(19) United States
(12) Patent Application Publication
(10) Pub. No.: US 2006/0133956 A1
(43) Pub. Date: Jun. 22, 2006

(54) Test strip holder

(76) Inventor: Kenichi Hamanaka, Matsuyama-shi (JP)

Correspondence Address: WENDEROTH, LIND & PONACK L.L.P., 2033 K. STREET, NW, SUITE 800, WASHINGTON, DC, 20006, US

(21) Appl. No.: 11/296,270

(22) Filed: Dec. 8, 2005

(30) Foreign Application Priority Data
Dec. 9, 2004 (JP) 2004-356367

(51) Int. Cl. B01L 9/00

(52) U.S. Cl. 422/68.1

(57) ABSTRACT

A test strip holder comprises a rectangular base having a concave part on its upper surface, arid a slidable moving part that is slidably fitted to the concave part of the base. When measuring the test strip, the test strip is reliably held between the base and the slidable moving part. After measurement, the test strip is ejected semiautomatically from the test strip holder by sliding of the slidable moving part with respect to the base. Therefore, the test strip after measurement, which has health problem and risk of infection, can be semiautomatically discarded without touching the test strip.

### FIELD OF THE INVENTION

The present invention relates to a test strip holder for holding a test strip and, more particularly, to a test strip holder which is able to eject a test strip easily and safely after measurement.

### BACKGROUND OF THE INVENTION

In the field of clinical diagnosis, the concentrations of components included in a solution to be tested (hereinafter referred to as a test solution) such as blood, blood plasma, blood serum, or urine collected from a test subject, or presence/absence of components included in the test solution are measured to perform diagnosis on the basis of the measurement result. Analysis apparatuses used for the measurement include a large-size apparatus used in a clinical laboratory or the like, and a small-size apparatus used for so-called POCT (Point Of Care Testing), with which the measurement result can be obtained right beside the test subject such as bed side. Generally, a reed-shaped test strip is used for the small-size apparatus. To be specific, a test strip is produced by applying and immobilizing a reaction liquid on its surface, and an analyte is applied onto the test strip to make the analyte react with the reaction liquid, thereby measuring or determining components in the analyte.

By the way, when multiple measurements are carried out in one analysis apparatus, contamination between analytes or reaction liquids must be avoided. Therefore, in the large-size apparatus, a reaction container is thrown away after use. On the other hand, in the small-size apparatus, only a test strip, which is relatively inexpensive and can be discarded at low cost, is thrown away after use.

The reaction container and the test strip used in the analysis apparatus have health problem and risk of infection in many cases. Therefore, when discarding the used reaction container and test strip, various methods have been proposed to prevent the operator from being subjected to danger.

In the large-size apparatus, generally, a used reaction container is grasped by a machinery or an instrument such as a robot arm, a belt conveyer, or a holder, and the reaction container is conveyed to be discarded into a waste box. Accordingly, when using the large-size apparatus, health problem due to the reaction container after use is almost avoided, but there still remain problems such as increased size of the apparatus, complicated maintenance, and high production cost.

On the other hand, when using the small-size apparatus, only the test strip is disposable in many cases, and therefore, there occurs no problem such as high production cost as in the large-size apparatus. However, in the conventional small-size apparatus, the user takes the used test strip after measurement out of the apparatus as it is or together with a fixture, by hand having a protector such as a versatile instrument or a glove, and further, the user directly grasps portion or periphery of the test strip to discard the test strip into a waste box, resulting in health problem and risk of infection.

For example, FIG. 17 is a diagram illustrating a conventional test strip holder. In FIG. 17, a test strip 701 is supported by a support 703 having a handle 704. An analyte is applied to an analyte addition part 706 of the test strip 701 with the support 703 being fixed to a guide 705 of a base 702, and the absorbance of a detector 707 is measured to measure or determine components in the analyte. After the measurement, the user directly grasps the handle 704 of the support 703 by hand or an instrument, and removes the test strip 701 together with the support 703 from the base 702 to discard the test strip (refer to Japanese Published Patent Application No. 2003-28876 (Pages 5-7, FIG. 1)).

However, when the User directly grasps the used test strip 701 by hand or an instrument to discard the same as described above, since the analyte spreads widely over the test strip 701 after measurement and thereby the analyte comes close to the handle 704, health problem and risk of infection to the user are considerable, and further, contamination might be spread to the apparatus and its periphery.

Furthermore, in the conventional method of picking up the test strip after measurement with a versatile instrument such as tweezers or the like to discard the same, the operation is complicated. Further, the method of picking up the test strip by hand to discard the same, a protector such as a glove must be prepared, leading to complication.

Especially when handling a substance that is harmful to human body or a substance that has risk of infection, such as blood, a protector is indispensable. However, even when a protector is used, since the operator comes close to the infectious source, there are cases where health problem and risk of infection are considerable due to mistake of the operator or flaw in the operation procedure.

### SUMMARY OF THE INVENTION

The present invention is made to solve the above-described problems and has for its object to provide a test strip holder that can discard a test strip after measurement semiautomatically without touching the test strip, which test strip has health problem and risk of infection.

Other object and advantages of the invention will become apparent from the detailed description that follows. The detailed description and specific embodiments described are provided only for illustration since various additions and modifications within the scope of the invention will be apparent to those of skill in the art from the detailed description.

According to a first aspect of the present invention, a test strip holder comprises a holding mechanism for holding a test strip which is inserted thereinto, and an ejection mechanism for dissolving the state where the test strip is held by the holding mechanism to eject the test strip. Therefore, it is possible to provide a test strip holder by which the user can eject and discard the test strip without touching the test strip.

According to a second aspect of the present invention, in a test strip holder according to the first aspect, the holding mechanism includes a slidable moving part disposed on a base, which is slidable in a direction parallel to a direction along which the test strip is inserted, and a first elastic member disposed in a predetermined position on the slidable moving part, which is engaged with the slidable moving part and presses the test strip against the base so that the slidable moving part holds the test strip between the slidable moving part and the base; and the ejection mechanism dissolves the state where the test strip is held by the slidable moving part in the holding mechanism, and ejects the test strip, when the slidable moving part is slid with respect to the base from the test strip holding state. Therefore, when the test strip is held in the test strip holder, the user is prevented from touching the test strip. Further, when the test strip is ejected, the user can discard the test strip easily and safely without touching the test strip.

According to a third aspect of the present invention, in the test strip holder according to the second aspect, the ejection mechanism includes an ejection button for changing the test strip holding state to a test strip holding dissolving state, the ejection button being disposed in a predetermined position on the base, moves the test strip up to a predetermined position on the base while maintaining the position where the test strip is held by the slidable moving part, when the slidable moving part is slid in a direction opposite to the test strip insertion direction with respect to the base, from the test strip holding state, stops the test strip at the predetermined position by the eject button, when the eject button is changed from the test strip holding state to the test strip holding dissolving state, and dissolves the test strip holding state and discards the test strip, when the slidable moving part is slid by a predetermined distance or more in the test strip insertion direction with respect to the base. Therefore, the test strip can be semiautomatically ejected and discarded, whereby the safety of the user can be ensured.

According to a fourth aspect of the present invention, the test strip holder according to the second aspect further includes a second elastic member disposed at a rear position on the base, the second elastic member pressing the slidable moving part against the base in the test strip insertion direction to restrict sliding of the slidable moving part in a direction opposite to the test strip insertion direction. Therefore, the slidable moving part can be held at a predetermined position on the base, whereby the test strip is prevented from being ejected from the test strip holder by mistake.

According to a fifth aspect of the present invention, in the test strip holder according to the second aspect, the ejection mechanism includes an ejection elastic member for pressing the test strip against the slidable moving part so as to eject the test strip, and presses the test strip by the ejection elastic member to eject the test strip after the test strip holding state is dissolved. Therefore, ejection of the test strip is promoted by the elastic member, whereby the test strip can be reliably ejected from the test strip holder to be discarded.

According to a sixth aspect of the present invention, in the test strip holder according to the first aspect, the holding mechanism includes a pivotable moving part disposed on a base, which is pivotable with respect to the base, and a third elastic member disposed in a predetermined position on the base, which presses the test strip against the base so that the test strip is fixedly held at the position between the pivotable moving part and the base; and the ejection mechanism dissolves the state where the test strip is held by the pivotable moving part, and ejects the test strip, when the pivotable moving part is pivoted upward with respect to the base from the test strip holding state. Therefore, when the test strip is ejected from the test strip holder, the user can discard the test strip easily and safely without touching the test strip.

According to a seventh aspect of the present invention, in the test strip holder according to the sixth aspect, the ejection mechanism includes an ejection button for changing the test strip holding state to a test strip holding dissolving state, the ejection button being disposed on the pivotable moving part, pivots the pivotable moving part upward with respect to the base, from the state where the test strip is held by the pivotable moving part, when the eject button is changed from the test strip holding state to the test strip holding dissolving state, and dissolves the test strip holding state and discards the test strip, when the pivot angle of the pivotable moving part becomes larger than a predetermined angle. Therefore, the test strip can be semiautomatically ejected and discarded, whereby the safety of the user can be ensured.

According to an eighth aspect of the present invention, the test strip holder according to the seventh aspect further includes a fourth elastic member disposed on the base, the fourth elastic member restricting upward pivoting of the pivotable moving part with respect to the base. Therefore, pivoting of the pivotable moving part is carried out only when the test strip is to be ejected, whereby the test strip is prevented from being ejected from the test strip holder by mistake.

According to a ninth aspect of the present invention, in the test strip holder according to the first aspect, the holding mechanism includes a slidable moving part disposed in a base, which is slidable in a direction parallel to the test strip insertion direction, and a fifth elastic member disposed in a predetermined position in the base, which fixedly holds the test strip at the position; and the ejection mechanism dissolves the state where the test strip is held by the holding mechanism, and ejects the test strip, when the slidable moving part is slid with respect to the base from the test strip holding state. Therefore, when the test strip is ejected from the test strip holder, the user can discard the test strip easily and safely without touching the test strip.

According to a tenth aspect of the present invention, the test strip holder according to the ninth aspect further includes a sixth elastic member disposed at a rear position in the base, the sixth elastic member pressing the slidable moving part against the base in the test strip insertion direction to restrict sliding of the slidable moving part in a direction opposite to the test strip insertion direction. Therefore, the ejection button can be held at a predetermined position in the base, whereby the test strip is prevented from being ejected from the test strip holder by mistake,

### BRIEF DESCRIPTION OF THE DRAWINGS

FIGS. 1(a)-1(c) are a perspective plan view, a perspective bottom view, end a cross-sectional view, respectively, illustrating the construction of a test strip holder according to a first embodiment of the present invention.

FIG. 2 is an exploded perspective view illustrating the test strip holder according to the first embodiment.

FIG. 3 is a diagram illustrating the state where the test strip holder of the present invention is set in a measurement apparatus.

FIGS. 4(a) and 4(b) are diagrams illustrating the relationships among a first elastic member, a reference plane, and a test strip in the test strip holder according to the first embodiment, wherein FIG. 4(a) shows the test strip holding state and FIG. 4(b) shows the test strip ejecting state.

FIGS. 5(a) and 5(b) are a plan view and a cross-sectional view, respectively, illustrating the state where an analyte is applied to a test strip held in the test strip holder of the present invention.

FIGS. 6(a)-6(d) are perspective views illustrating the test strip holding state (6(a)), the moving part sliding state (6(b)), the eject button operating state (6(c)), and the test strip ejecting state (6(d)) of the test strip holder of the first embodiment.

FIGS. 7(a)-7(d) are cross-sectional views illustrating the test strip holding state (7(a)), the moving part sliding state (7(b)), the eject button operating state (7(c)), and the test strip ejecting state (7(d)) of the test strip holder of the first embodiment.

FIG. 8 is a diagram illustrating the state where a test strip is discarded from the test strip holder according to the first embodiment.

FIGS. 9(a) and 9(b) are a perspective plan view and a cross-sectional view, respectively, illustrating the construction of a test strip holder according to a second embodiment of the present invention.

FIG. 10 is an exploded perspective view of the test strip holder according to the second embodiment.

FIGS. 11(a) and 11(b) are perspective views illustrating the test strip holding state (11(a)) and the test strip holding dissolving state (11(b)) of the test strip holder according to the second embodiment.

FIGS. 12(a) and 12(b) are cross-sectional views illustrating the test strip holding state (12(a)) and the test strip holding dissolving state (12(b)) of the test strip holder according to the second embodiment.

FIG. 13 is a diagram illustrating the state where a test strip is discarded from the test strip holder according to the second embodiment.

FIGS. 14(a) and 14(b) are a plan view and a A-A cross-sectional view, respectively, illustrating the construction of a test strip holder according to a third embodiment of the present invention.

FIGS. 15(a) and 15(b) are cross-sectional views illustrating the test strip holding state (15(a)) and the eject button sliding state (15(b)) of the test strip holder according to the third embodiment.

FIG. 16 is a diagram illustrating the state where a test strip is discarded from the test strip holder according to the third embodiment of the present invention.

FIG. 17 is a perspective view illustrating the conventional test strip holder.

### DETAILED DESCRIPTION OF THE PREFERRED EMBODIMENTS

Hereinafter, embodiments of test strip holderes according to the present invention will be described with reference to the drawings The embodiments described below are merely examples, and the present invention is not restricted thereto.

### Embodiment 1

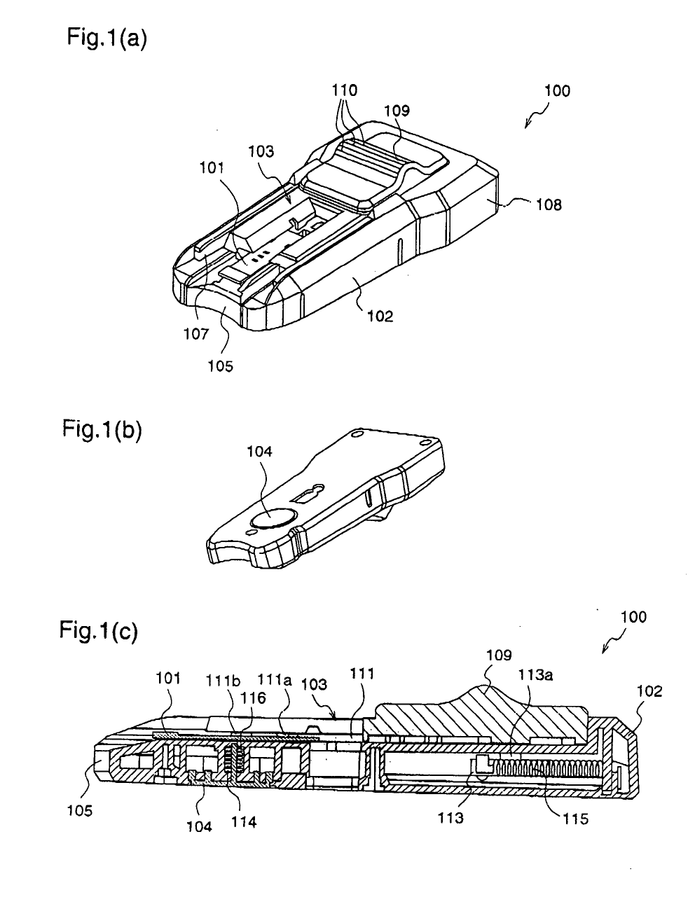

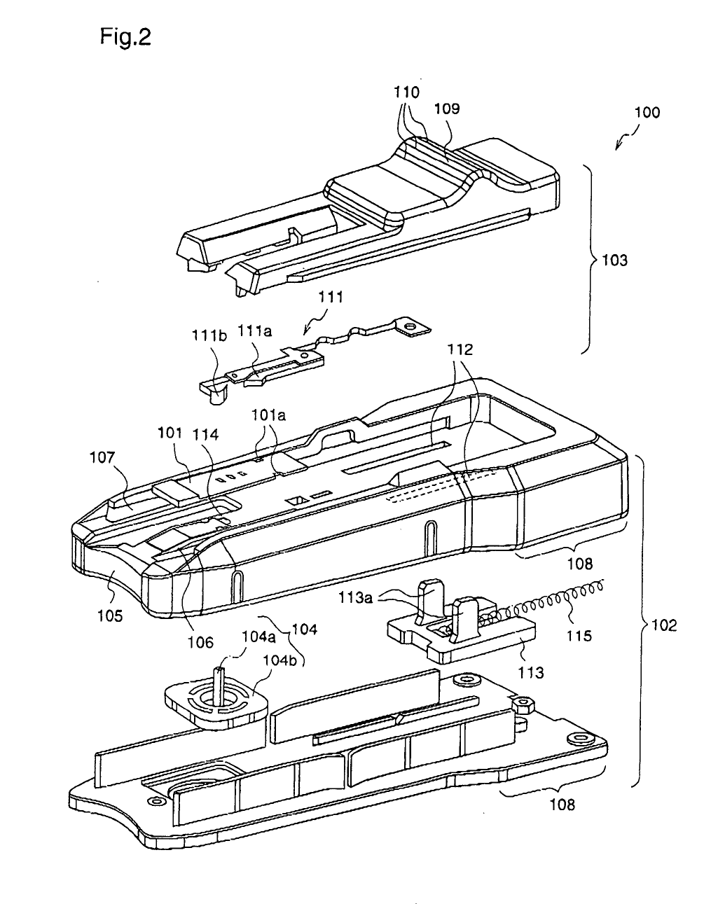

FIGS. 1(a)-1(c) are a perspective plan view, a perspective bottom view, and a cross-sectional view, respectively, for explaining the construction of a test strip holder according to the present invention. FIG. 2 is an exploded perspective view of the test strip holier of the first embodiment.

With reference to the figures, the test strip holder 100 of the first embodiment includes a rectangle base having a concave part at its upper surface, and a slidable moving part 103 that is slidably fitted into the concave part of the base 102. When measuring the test strip 101, the test strip 101 is reliably held between the base 102 and the slidable moving part 103, and after measurement, the slidable moving part 103 is slid with respect to the base 102, thereby semiautomatically ejecting the test strip 101 from the test strip holder 100.

The test strip holder 100 is desirably composed of a material having a stiffness which is not deformed when being pressed with fingers, such as plastic, metal, or hard rubber. Further, a method of forming the shape of the test strip holder 100 may be selected from among molding, cutting, and pressing. In view of cost, plastic molding is most preferable.

Further, the material of the test strip holder 100 is desired to have a chemical resistance so that a test solution attached thereto can be washed with a cleaning solution that is ordinary used in hospitals and laboratories.

Furthermore, the respective components of the test strip holder 100 may be decomposable so that the user can easily wash the test strip holder 100. On the other hand, the test strip holder 100 may be sealed so as not to be decomposed in order to avoid missing or breakage of the components during washing.

Hereinafter, the construction of the test strip holder 100 of this first embodiment will be described in detail. Initially, the best strip 101 held by the test strip holder 100 is a reed-shaped test strip having a size of about 6 mm×about 30 mm, and has, on one surface, a color region to be a target of measurement. Thereby, the test strip 101 can determine the components of blood or presence/absence of germs by a staining method based on the immunochromatography method or the latex aggregation method. Further, the test strip 101 has a pair of notches 101a on the both side surfaces in the longitudinal direction.

The base 102 is formed of a rigid body having a rectangle shape of about 40 mm×about 90 mm, and is provided with slide guides 107, a reference plane 106, slots 112, a slide stopping mechanism 113, and an ejection button 104. The base 102 has a function of holding the test strip 101, a function of sliding the slidable moving part 103 in the longitudinal direction of the base 102, and a function of latching the slidable moving part 103 in a predetermined position on the base 102.

Hereinafter, the respective components of the base 102 will be described in detail. The slide guides 107 are provided on the both side surfaces of the concave part of the base 102 to guide the slidable moving part 103. Thereby, the motion of the slidable moving part 103 in the vertical direction and the transversal direction will respect to the base 102 is restricted so that it can smoothly slide in the longitudinal direction. Further, the slide guide 107 is located in a position where an appropriate gap for holding the test strip 101 is made, between the lower surface of the slidable moving part 103 and the upper surface of the concave part of the base 102. Thereby, the test strip 101 is inserted between the base 102 and the slidable moving part 103 to house the test strip 101 in the test strip holder 100.

Further, the reference plane 106 is a surface of a plate which is provided on the upper surface of the concave part of the base 102 in the longitudinal direction, and it is positioned higher than the thickness of the test strip 101 and is longer than the length of the test strip 101. The reference plate 106 is provided for reliably holding the test strip 101 on the test strip holder 100.

Further, the slots 112 are two narrow holes formed on the upper surface of the concave part of the base 102 in the longitudinal direction, and the slide stopping mechanism 113 has two projection-shaped stopping parts 113a which are fitted to the slidable moving part 103 through the slots 112. The stopping parts 113a restrict the sliding distance of the slide stopping mechanism 113 in the longitudinal direction by the slots 112, whereby the stopping parts 113a serve as a stopper for stopping the slidable moving part 103 at a predetermined position.

A second elastic member 115 such as a coil spring for pressing the slidable moving part 103 backward in the longitudinal direction to restrict the forward sliding of the moving part 103 is provided at a rear position in the longitudinal direction of the base 102. Thereby, the slidable moving part 103 does not move unless the user applies a force against the slidable moving part 103, and therefore, the test strip is prevented from being ejected from the test strip holder 100 by mistake.

The eject button 104 changes the state of the test strip 101 that is held between the base 102 and the slidable moving part 103, from the hold state to the release state. To be specific, the eject button 104 is provided with a plane part 104b and a columnar projection part 104a connected to the plane part 104b. When the user wants to eject the test strip 101, the user presses the plane part 104b toward the inside of the base 102. Thereby, the projection part 104a moves vertically along a projection part guide 114 that is provided inside the base 102, and protrudes over the base 102. Then, the protruded projection part 104a temporarily stops the test strip 101 to support ejection of the test strip 101. That is, before changing the state of the test strip 101 to the release state using the eject button 104, when the slidable moving part 103 is slid, the slidable moving part 103 can make the test strip 101 slide with respect to the base 102 while maintaining the holding state. After the state of the test strip 101 is changed to the release state by the eject button 104, the test strip 101 is stopped at a predetermined position on the base 102 by the projection part 104a on the base 102. In this state, when the slidable moving part is slid, only the slidable moving part 103 slides with respect to the base 102, whereby the test strip 101 which is housed in a space between the base 102 and the slidable moving part 103 can be pushed out of the test strip holder 100.

In this first embodiment, a plane part 104b of the eject button 104 is disposed at the rear surface of the base 102 and at the front of the base 102 in the longitudinal direction. Since the eject button 104 is disposed in a position that is hard for the user to touch, erroneous operation of the eject button 104 by the user is avoided, and further, the user can operate the eject button 104 easily with one hand, resulting in improved usability of the test strip holder 100.

Furthermore, in this first embodiment, the elastic member 116 such as a coil spring for restricting the operation of the eject button 104 is disposed in the projection part guide 114. Since the projection part 104a is usually controlled so as not to protrude over the upper surface of the base 102, the projection part 104a of the eject button 104 does not protrude over the surface of the base 102 unless the user consciously presses the eject button 104, thereby preventing the test strip 101 from being ejected from the test strip holder 100 by mistake.

In addition to the above-mentioned constituents, the base 102 is provided with a dent 105 at an end of the front part of the base 102 in the longitudinal direction, on the side where the test strip 101 is set, and a handle part 108 at the other end of the base 102 in the longitudinal direction.

When an analyte is applied onto the test strip 101 held by the test strip holder 100, the dent 105 prevents the analyte from adhering to the test strip holder 100. Since the dent 105 is provided on the base 102, the base 102 can be easily kept clean, whereby the trouble of washing or decontaminating the base 102 can be saved, resulting in improved usability of the test strip holder 100.

Since in this first embodiment blood is collected directly from a fingertip and applied to the test strip 101, the shape of the dent 105 is similar to the shape of a fingertip, i.e., semicircle or ellipse having a radius of 8 mm˜20 mm. However, the shape of the dent 105 is not necessarily similar to the shape of a fingertip. For example, when an analyte is applied to the test strip 101 using an instrument, the shape of the dent 105 should be similar to the shape of the instrument. Alternatively, when blood is applied directly from an ear lobe to the test strip 101, the shape of the dent 105 should be similar to the shape of an ear lobe.

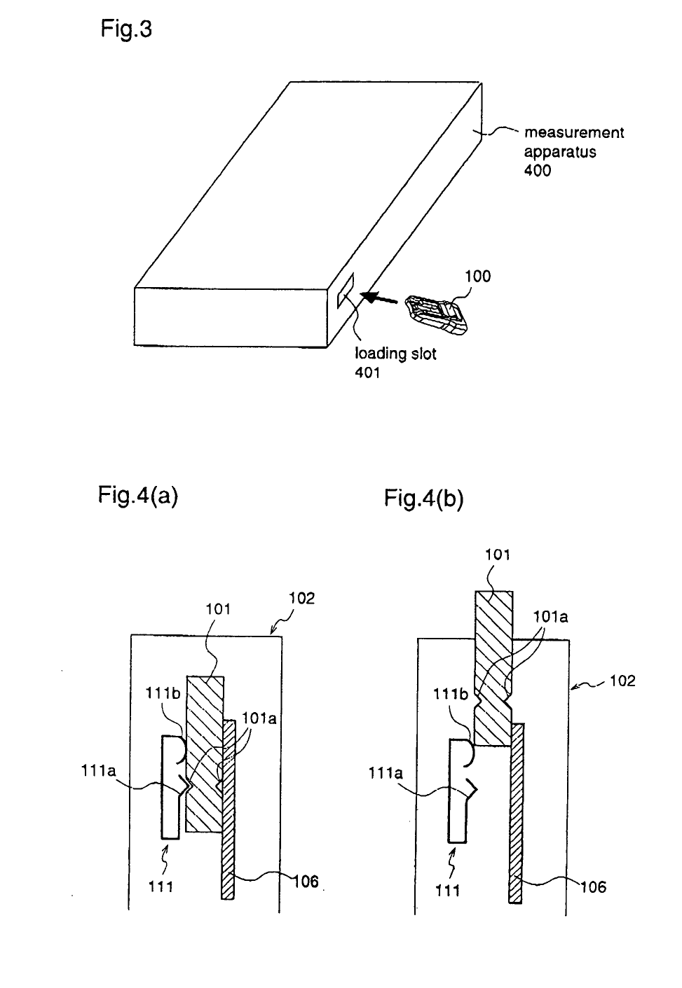

The handle part 108 is obtained by increasing the dimension of the base 102 in the transverse direction so that the user can easily hold the base 102. In this first embodiment, the dimension of the handle part 108 in the transverse direction is about 20 mm˜60 mm which is easy for adult to hold. Further, when the test strip holder 100 is inserted to a loading slot 401 of a measurement apparatus 400 as shown in FIG. 3, this handle part 100 enables correct positioning of the test strip 101 in the measurement apparatus 400, thereby preventing false detection of measurement result. Further, since the handle part 108 surely fills a gap between the measurement apparatus 400 and the test strip holder 100, disturbance during measurement can also be prevented.

Next, the slidable moving part 103 contains a first elastic member 111 such as a plate spring, and it has a function of holding the test strip 301 in the transverse direction, and a function of sliding the test strip 101 after measurement to eject the test strip 101 from the test strip holder 100.

The first elastic member 111 has, as shown in FIG. 2, two elastic parts, i.e., a hook-shaped first elastic part 111a, and a semicircular second elastic part 111b.

Hereinafter, the first elastic member 111 will be described in more detail with reference to FIGS. 4(a) and 4(b). FIGS. 4(a) and 4(b) are schematic diagrams illustrating the relationships among the first elastic member 111, the test strip 101, and the reference plane 106 disposed on the base 102, in the test strip holder of the first embodiment. To be specific, FIG. 4(a) shows the slate where the test strip 101 is held, and FIG. 4(b) shows the state where the test strip 101 is ejected.

The first elastic part 111a of the first elastic member 111 is disposed near the center of the body of the first elastic member 111, and this first elastic part for holding is used for pressing the test strip 101 against the base 102 so that the test strip 101 is held on the base 102, as shown in FIG. 4(a). To be specific, in the state where the test strip 101 is held, the first elastic part 111a is fitted into the notch 101 of the test strip 101, and the tip of the hook-shaped portion of the first elastic part 111a pushes one side of the test strip 101 in the longitudinal direction to press the one side of the test strip 101 against the reference plane 106, whereby the test strip 101 is held reliably.

On the other hand, the second elastic part 111b of the first elastic member 111 is disposed at an end of the body of the first elastic member 111, and this second elastic part for ejection is used for pushing the test strip 101 to eject the same from the test strip holder 100, as shown in FIG. 4(b). To be specific, when ejecting the test strip 101 from the test strip holder 100, the tip of the semicircular portion of the second elastic part 111b pushes a corner of the test strip 101 to apply a force in the direction along which the test strip 101 should be ejected, whereby the test strip 101 is protruded about 10 cm from the base 102 and thus the test strip 101 is reliably ejected from the test strip holder 100.

As described above, since the slidable moving part 103 is provided with the first elastic member 111, the test strip 101 can be reliably held in the test strip holder 100 during measurement to avoid occurrence of errors in the measurement result. After the measurement, the test strip 101 can be reliably ejected from the test strip holder 100 even though the user does not touch the test strip 101, whereby safety of the user can be ensured.

In this first embodiment, since the body of the first elastic member 111 has the two elastic parts, i.e., the first elastic part 111a having the test strip holding function and the second elastic part 111b having the test strip ejection function, assembling of the test strip holder 100 is facilitated, and further, cost reduction is achieved. Further, the first elastic part 111a and the second elastic part 111b of the first elastic member 111 are disposed on the same side, with an interval between them, thereby preventing the test strip 101 from being held at a tilt in the test strip holder 100.

Further, the slidable moving part 103 has a U-shaped end in the longitudinal direction. When the test strip 101 is held in the test strip holder 100, the color region of the test strip 101 is exposed at an opening of the U-shaped part. A light beam is applied from the measurement apparatus 400 through this opening to the upper surface of the test strip 101 to measure the result of reaction on the color region, or to take an image of the color region, or to bring an instrument into contact with the test strip 101.

Furthermore, the slidable moving part 103 is provided with a mountain-shaped slidable projection part 109 which protrudes about 5 mm˜20 mm from the plane part of the slidable moving part 103. Therefore, the force of pressing the slidable moving part 103 by the user can be allocated a lot in the sliding direction, and friction between the slidable moving part 103 and the base 102 is reduced, thereby improving usability of the test strip holder 100 and permanence against abrasion. Furthermore, in this first embodiment, the shape of the curve of the slidable projection part 109 is similar to the shape of a fingertip, force can be easily conducted in the sliding direction. Of course, the shape of the curve of the slidable projection part 109 is not restricted to the above-mentioned shape, and it may be any shape so long as a force can be easily conducted in the sliding direction.

Further, a part of the upper surface of the slidable projection part 109 is subjected to knurling 110 having a notched pattern, a waved pattern, or a pattern in which portions of columns are exposed, at a pitch of about 0.5 mm˜5 mm. Thereby, the gripping feeling of the slidable projection part 109 is increased, and the slidable moving part 103 can be slid more smoothly and reliably, resulting in improved usability of the test strip holder 100. While in this first embodiment only a part of the slidable projection part 109 is subjected to the knurling 110 as shown in FIGS. 1 to 3, the entire upper surface of the slidable moving part 103 may be subjected to the knurling.

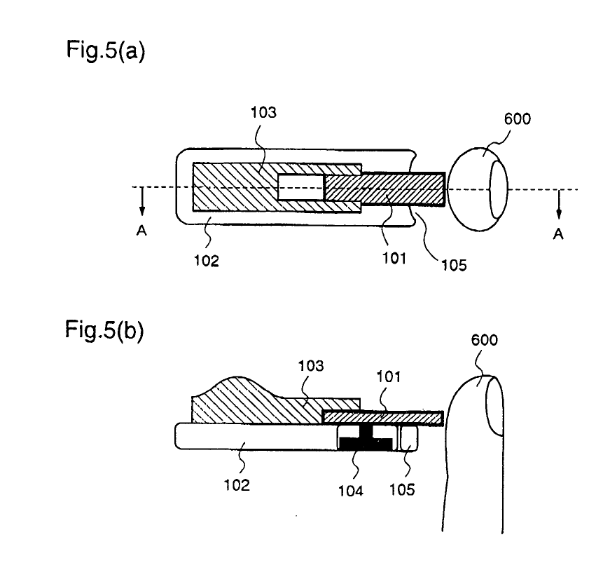

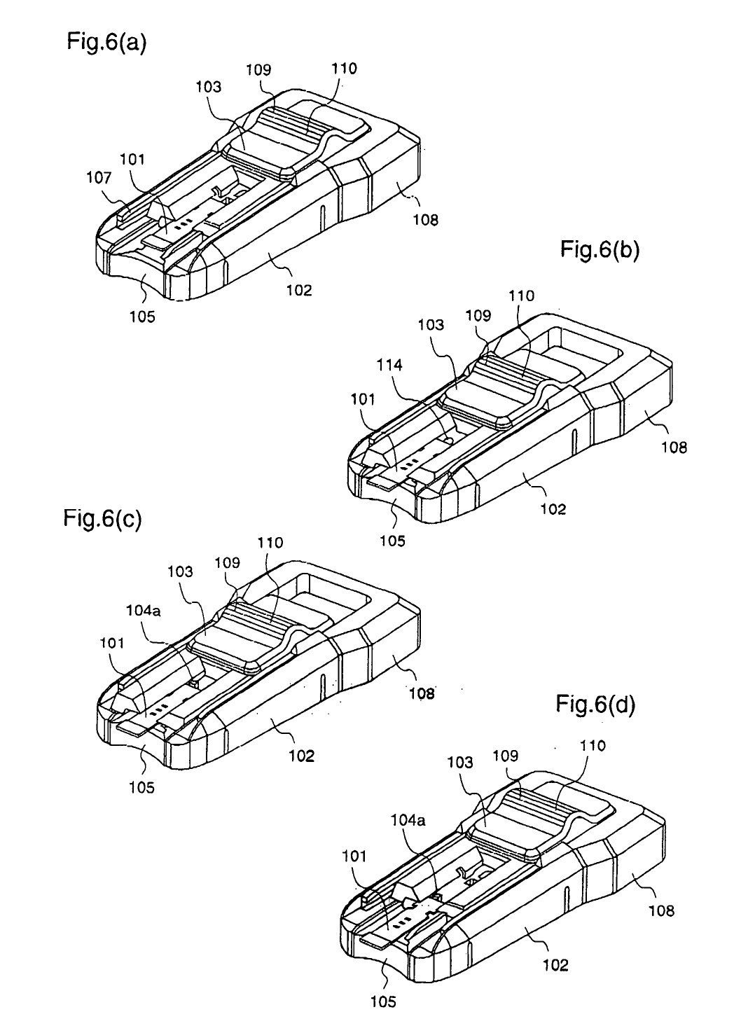

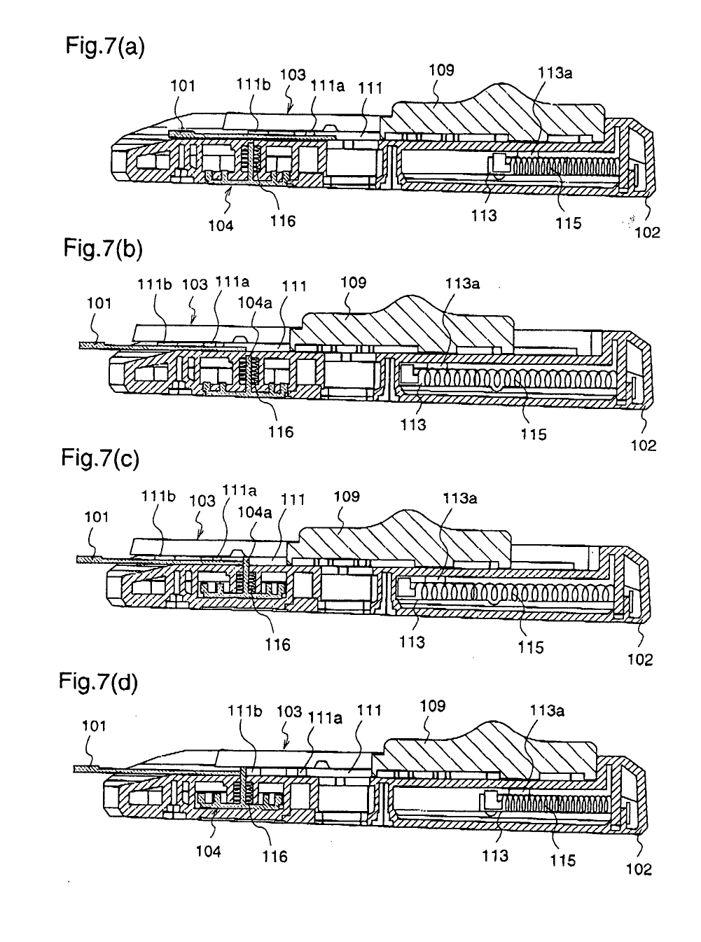

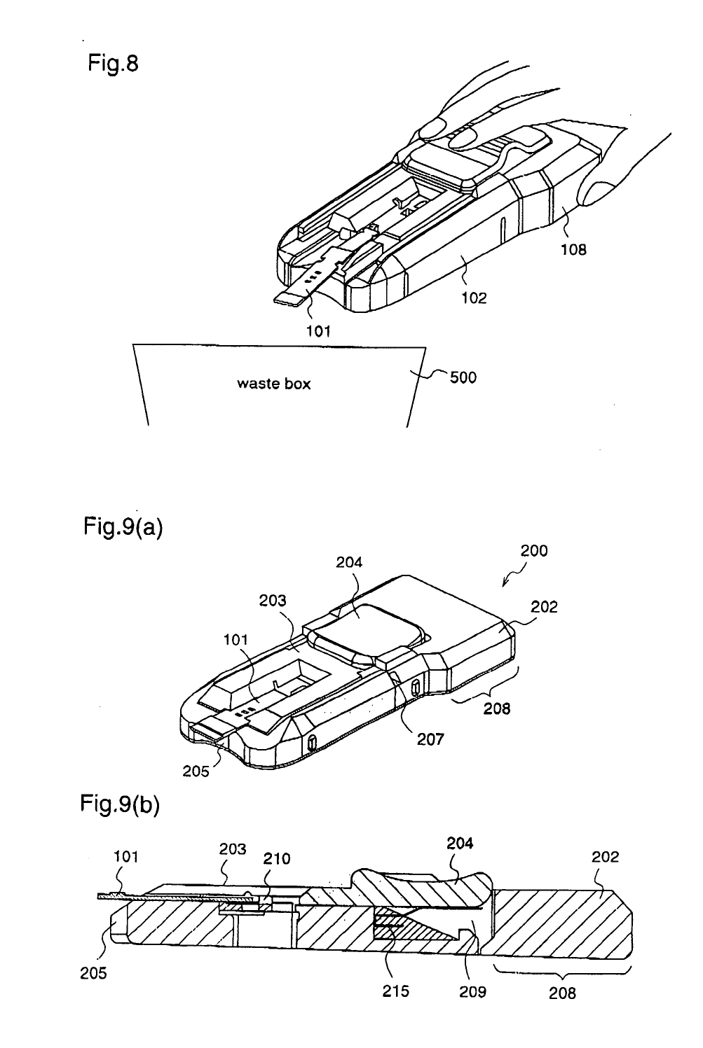

Next, a description will be given of the operation from when the test strip 101 is set in the test strip holder 100 of the first embodiment to when the test strip 101 is ejected, with reference to FIGS. 5 to 8. FIGS. 5(a) and 5(b) are schematic views illustrating the state where an analyte is applied to the test strip that is held by the test strip holder of the first embodiment. FIG. 5(a) is a plane view, and FIG. 5(b) is a cross-sectional. view taken along a line A-A in FIG. 5(a). FIGS. 6(a)-6(d) are perspective views illustrating the test strip holding state (6(a)), the moving part sliding state (6(b)), the eject button operating state (6(c)), and the test strip ejecting state (6(d)) of the test strip holder of the first embodiment. FIGS. 7(a)-7(d) are cross-sectional views of the respective states shown in FIGS. 6(a)-6(d) . Further, FIG. 8 shows the state where the test strip is discarded.

Initially, the user inserts the test strip 101 between the base 102 and the slidable moving part 103 to set the test strip 101 into the test strip holder 100. At this time, the user presses the test strip 101 until the notch 101a of the test strip 101 is fitted to the first elastic part 111a of the first elastic member 111. The state of the test strip holder 100 in which the test strip 101 is held is shown in FIGS. 6(a) and 7(a). When setting the test strip 101 in the test strip holder 100, the user may press the slidable protection part 109 forward in the longitudinal direction with his/her finger to slide the slidable moving part 103 forward along the slide guide 107, and thereafter, the user may insert the test strip 101 between the slidable moving part 103 and the base 102. In this case, since the first elastic part 111a is positioned at the front part of the base 102, the first elastic part 111a is easily fitted into the notch 101a, thereby facilitating setting of the test strip 101.

After the test strip 101 is inserted between the base 102 and the slidable moving part 103, an analyte such as blood is applied to the held test strip 101. At this time, initially, the user presses the slidable projection part 109 forward to slide the slidable moving part 103 along the slide guide 107 forward in the longitudinal direction of the base 102, whereby the test strip 101 protrudes from the base 102, as shown in FIGS. 6(b) and 7(b). Then, as shown in FIGS. 5(a)-5(b), blood is applied to the test strip 101 that protrudes from the base 102, directly from a fingertip 600 of a test subject. Thereafter, the protruding test strip 101 is slid backward in the longitudinal direction of the base 102 to return the test strip holder 100 to the test strip holding state shown in FIGS. 6(a) and 7(a). When the test strip 101 is held in the state where the test strip 101 is located between the slidable moving part 103 and the base 102 in the test strip holder 100 as shown in FIG. 6(a), the user cannot touch the test strip 101. Thereby, even if the analyte applied to the test strip 101 is dangerous one, the safety of the user is ensured.

Thereafter, the test strip holder 100 in its test strip holding state is inserted into the measurement apparatus 400 as shown in FIG. 3 to obtain measurement result. When the test strip holder 100 is inserted, the measurement apparatus 400 applies a light beam onto the upper surface of the test strip 101 to measure the result of reaction on the color region of the test strip 101, or to take an image of the color region, or to bring an instrument into contact with the test strip 101, thereby obtaining measurement result. After the measurement by the measurement apparatus 400 is ended, the test strip holder 100 is ejected from the measurement apparatus 400 while maintaining the test strip holding state as shown in FIGS. 6(a) and 7(a).

Thereafter, the used test strip 101 is ejected from the test strip holder 100. Initially, the user presses the slidable projection part 109 of the slidable moving part 103 forward in the longitudinal direction with his/her finger to slide the slidable moving part 103 along the slide guide 107 disposed on the base 102. At this time, the test strip 101 held by the first elastic member 111 of the slidable moving part 103 also moves forward in the longitudinal direction on the base 102 in accordance with the sliding of the slidable moving part 103. Thereby, the slidable moving part 103 moves up to a predetermined position where the slide stopping mechanism 113 is locked by the slots 112 as shown in FIG. 7(b), and the test strip 101 protrudes from the test strip holder 100 as shown in FIG. 6(b).

After the moving part 113 is slid to the predetermined position as described above, the user pushes the eject button 104 provided on the bottom surface of the test strip holder 100 toward the inside of the base 102. As a result, as shown in FIGS. 6(c) and 7(c), the projection 104a of the eject button 104 protrudes over the base 102 and contacts one side of the test strip 101, whereby the test strip 101 is stopped at that position.

Thereafter, the slidable moving part 103 is returned backward in the longitudinal direction while maintaining the position where the test strip 101 is stopped by the projection 104a, and only the slidable moving part 103 is moved as shown in FIGS. 6(d) and 7(d). At this time, since the test strip 101 cannot move because it is stopped by the projection 104a, holding of the test strip 101 by the first elastic part 111a of the first elastic member 111 is released, and the test strips 101 is pushed out relatively from the slidable moving part 103. To be specific, when only the slidable moving part 103 is sliding backward in the longitudinal direction while maintaining the position where the test strip 101 is stopped by the projection 104a, initially the first elastic part 111a of the first elastic member 111, which is fitted in the notch 101a of the test strip 101, removes from the notch 101a, whereby the test strip holding state is dissolved. When the slidable moving part 103 is further slid backward in the longitudinal direction, the second elastic part 111b moves in contact with the side of the test strip 101. When the second elastic part 111b finally contacts the corner of the test strip 101 (refer to FIG. 4(b)), the second elastic part 111b pushes the test strip 101, whereby the test strip 101 is ejected such that it is jumped out of the test strip holder 100.

Accordingly, when the above-mentioned test strip ejecting operation of the test strip holder 160 after measurement is carried out above a waste box 500 while holding the handle part 108 of the test strip holder 100 to keep the test strip holder 100 in a horizontal position with respect to the ground or in a downward direction from the horizontal position as shown in FIG. 8, the test strip 101 can be ejected semiautomatically from the test strip holder 100 and discarded, without touching the test strip 101.

As described above, the test strip holder 100 of the first embodiment is provided with the rectangular base 102, the slidable moving part 103 which is slidably provided in the longitudinal direction on the base 102, and the first elastic member 111 for pressing the test strip 101 against the base 102 so as to hold the test strip 101 at a predetermined position on the slidable moving part 103, and the test strip 101 which is held between the base 102 and the slidable moving part 103 is released from the hold state by sliding the slidable moving part 103 in the longitudinal direction, thereby ejecting the test strip 101 from the test strip holder 100. Therefore, the user can easily and safely eject the test strip 101 from the test strip holder 100 to discard the same, without directly touching the test strip 101. This construction is useful in ensuring the safety of the user when the analyte applied to the test strip 101 includes blood, mold, or other harmful substances.

Further, the base 102 is provided with the ejection button 104 for changing the state of the test strip holder 100 from the test strip holding state to the test strip releasing state. When ejecting the test strip 101, the ejection button is changed to the test strip releasing state to make the projection 104a of the ejection button 104 protrude over the base 102, and the test strip 101 which is moved forward in the longitudinal direction with the slidable moving part 103 is stopped at a predetermined position on the base 102, and further, the slidable moving part 103 is slid backward in the longitudinal direction to dissolve the test strip holding state by the slidable moving part 103, whereby the test strip 101 is ejected from the test strip holder 100. Therefore, only when the user selects ejection of the test strip 101, the test strip 101 is easily and safely ejected from the test strip holder 100 and discarded. When the user does not select ejection of the test strip 101, the test strip 101 can be moved forward and backward in the longitudinal direction, with the test strip 101 being held by the slidable moving part 103. As a result, the test strip 101 is usually housed between the slidable moving part 103 and the base 102 to keep the state where the user cannot directly touch the test strip 101, and the test strip 101 can be slid to a position where, the user can touch the test strip 101 only when it is necessary, whereby the safety of the user is further ensured.

Furthermore, according to the first embodiment, since the slide stopping mechanism 113 is connected to the base 102 through the second elastic member 115, the slidable moving part 103 is fixed at a predetermined position on the base 102 unless the user applies a force to the slidable moving part 103, thereby preventing the test strip 101 from being ejected by mistake.

Furthermore, the slidable moving part 103 is provided with the first elastic member 111 comprising the two elastic parts, i.e., the hook-shaped first elastic part 111a and the semicircular second elastic part 111b. Therefore, the test strip 101 can be reliably held in the test strip holder 100 by the first elastic part 111a, and further, ejection of the test strip 101 is promoted by the second elastic part 111b so as to reliably eject the test strip 101 from the test strip holder 100 without the user's touching the test strip 101.

While in this first embodiment the first elastic member 111 comprises a plate spring, the first elastic member 111 may comprise a coil spring and a projection mechanism, or a so-called plastic spring utilizing characteristics of plastic. Further, while in this first embodiment the second elastic part 111b of the first elastic member 111 is semicircular in shape, the second elastic part 111b may have any shape so long as a portion thereof that contacts the notch 101a of the test strip 101 is curved. For example, the second elastic part 111b may have a shape in which a curvature of an apex of an acute angle is increased. Moreover, a force to be applied to the test strip 101 by the second elastic part 111b may be determined considering such as the weight and the shape of the test strip 101, and it is preferable to apply a force which makes the test strip 101 protrude several centimeters to several tens of centimeters from the test strip holder 100.

Furthermore, while in this first embodiment the projection 104a of the eject button 104 is columnar in shape, the projection 104a may have any shape. However, preferably the projection 104a should have a plane face in a part thereof that contacts the test strip 101. In this case, the test strip 101 can be stopped at a predetermined position with higher reliability, thereby preventing errors in the ejecting operation.

Moreover, a portion of the projection 104a of the ejection button 104, which is viewed from above the base 102, may be triangle or arrow-shaped so as to indicate the direction along which the test strip 101 should be inserted, whereby the test strip insertion direction can be indicated to the user in addition to the above-mentioned effects.

While in this first embodiment the base 102 is rectangular in shape, the shape of the base 102 is not restricted thereto. The base 102 may have any shape, such as trapezoid, a shape including a curve in a portion thereof, ellipse, triangle, or the like. Regardless of the shape of the base, the slidable moving part 103 is provided on the base 102 as in the above-mentioned construction and, when holding the test strip 101, the test strip 101 is inserted between the base 102 and the slidable moving part 103. On the other hand, when ejecting the test strip 101, the slidable moving part 103 is slid in a direction parallel to the test strip insertion direction with respect to the base 102 to dissolve the state where the test strip is held between the base 102 and the slidable moving part 103, thereby ejecting the test strip.

### Embodiment 2

In the above-mentioned first embodiment, the test strip, which is held between the base and the slidable moving part, is ejected from the test strip holder by sliding the slidable moving part disposed on the base. In this second embodiment, however, the test strip which is held on the base is ejected from the test strip holder by pivoting of the moving part.

Hereinafter, the lest strip holder according to the second embodiment will be described.

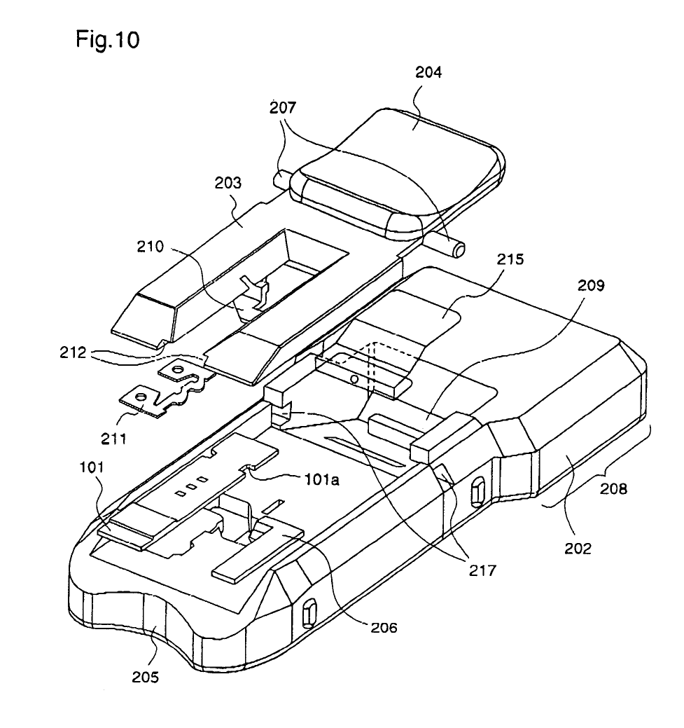

FIGS. 9(a) and 9(b) are a perspective plan view and a cross-sectional view, respectively, illustrating the construction of a test strip holder according to the second embodiment. FIG. 10 is an exploded perspective view of the test strip holder of the second embodiment.

With reference to the figures, the test strip holder 200 of the second embodiment is provided with a rectangular base 202 having a concave part at its upper surface, and a pivotable moving part 203 which is pivotably held by that a shaft 207 is fitted into a bearing 217 provided in the base 202. When measuring the test strip 101, the test strip 101 is reliably held between the base 202 and the pivotable moving part 203 and, after measurement, the pivotable moving part 203 is pivoted upward with respect to the base 202 to semiautomatically eject the test strip 101 from the test strip holder 200. Since the materials of the constituents of the test strip holder 200 are identical to those described for the first embodiment, repeated description is not necessary.

Hereinafter, the construction of the test strip holder 200 according to the second embodiment will be described in detail. The test strip 101 to be held in the test strip holder 200 is identical to that described for the first embodiment.

The base 202 is made of a rectangular rigid body having a size of about 40 mm×about 90 mm. The base 202 comprises a reference plane 206, a clearance groove for pivoting the pivotable moving part 203 on the base 202, a third elastic member 211 for pressing the test strip 101 against the reference plane 206 on the base 202 so that the test strip 101 is fixedly held between the pivotable moving part 203 and the base 202, a fourth elastic member 215 for restricting the upward pivoting of the pivotable moving part 203 with respect to the base 202, and a bearing 217 for receiving the shaft 207 of the pivotable moving part 203, and the base 202 has a function of holding the test strip 101, and a function of pivoting the pivotable moving part 203. The third elastic member 211 is preferably a plate spring or a plastic spring in view of the space and cost, and the fourth elastic member 215 is preferably a plate spring or a plastic spring in view of the space, cost, and strength.

Furthermore, the base 202 is provided with, as in the first embodiment, a dent 205 at an end of the front part of the base 102 in the longitudinal direction, on the side where the test strip 101 is set, and a handle part 208 at the other end of the base 102 in the longitudinal direction. Since the shapes and constructions of the above-mentioned parts and the effects obtained by providing the base 202 with these parts are identical to those already described for the first embodiment, repeated description is not necessary.

Next, the pivotable moving part 203 is formed in one body with an eject button 204 for changing the state where the test strip 101 is held between the base 202 and the pivotable moving part 203 to the state where the test strip 101 is released. The pivotable moving part 203 is provided with a shaft 207 for pivoting the moving part 203 with respect to the base 202, and an arm 210 for separating the test strip 101 front the base 202, and the pivotable moving part 203 has a function of releasing holding of the test strip 101 after measurement and ejecting the test strip 101 from the test strip holder 200.

Hereinafter, the respective constituents of the pivotable moving part 203 will be described in detail.

The eject button 204 is disposed backward in the longitudinal direction on the side opposite to the side where the test strip 101 is set, across the shaft 207 of the pivotable moving part 203. Since the clearance groove 209 is provided on the base 202 beneath the eject button 204, when the eject button 204 is pushed downward, the eject button 204 pivots around the shaft 207 and gets into the clearance groove 209, whereby the pivotable moving part 203 can be pivoted around the shaft 207 upward with respect to the base 202. In this first embodiment, it is assumed that the pivotable moving part 203 can pivot up to a position of about 45° from the horizontal position with respect to the base 202.

Further, in this second embodiment, the fourth elastic member 215 such as a plate spring for restricting upward pivoting of the pivotable moving part 203 with respect to the base 202 is disposed in the clearance groove 209 beneath the eject button 204, and pivoting of the pivotable moving part 203 is restricted by the fourth elastic member 215. Accordingly, in the normal state, the pivotable moving part 203 covers the test strip 101 on the base 202.

The arm 210 is disposed in a position on the bottom surface of the pivotable moving part 203 where the arm 210 can hold an end of the test strip 101 when the test strip 101 is held between the base 202 and the pivotable moving part 203, as shown in FIG. 9(b). When the pivotable moving part 203 is moved upward, the arm 210 holds up the test strip 101 to promote ejection of the test strip 101.

Further, a front end of the pivotable moving part 203 in the longitudinal direction is U-shaped as in the first embodiment. When the test strip 101 is held in the test strip holder 200, the color region of the test strip 101 is exposed at an opening of the U-shaped part. A light beam is applied from the measurement apparatus 400 through this opening to the upper surface of the test strip 101 to measure the result of reaction on the color region, or to take an image of the color region, or to bring an instrument into contact with the test strip 101.

Further, an appropriate space for receiving and holding the test strip 101 is provided between the lower surface of the pivotable moving part 203 and the upper surface of the base 202, and the arm 210 is disposed in the rear position of this space.

Furthermore, in this second embodiment, when the test strip 101 is inserted into the space between the lower surface of the pivotable moving part 203 and the upper surface of the base 202, in order to insert the test strip 101 smoothly up to the arm 210 located in the rear position of the space, guides 212 are provided at the end surfaces of the space, i.e., at the bottom surface of the both inner sides of the U-shaped part of the pivotable moving part 203.

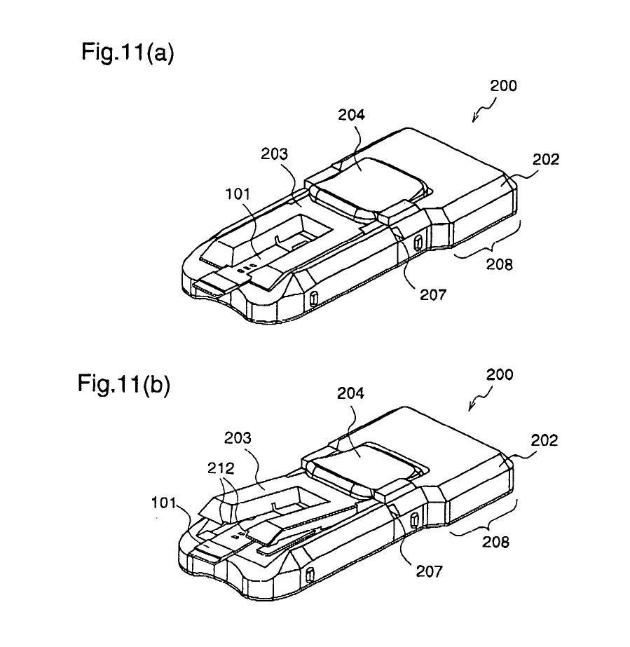

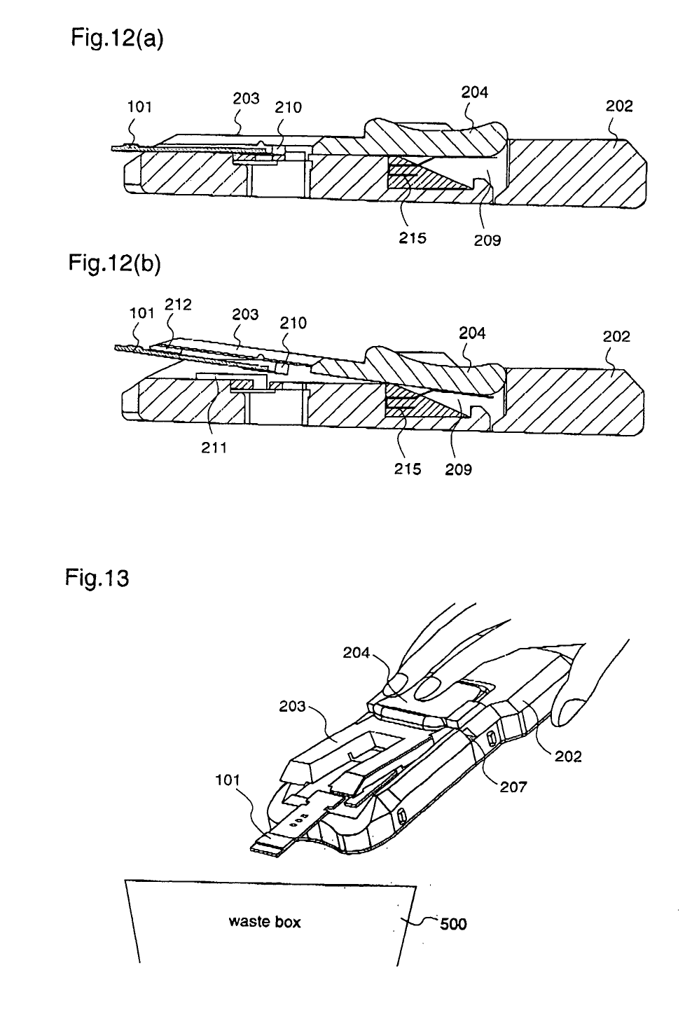

Next, a description is given of the operation from when the test strip 101 is set in the test strip holder 200 to when the test strip 101 is ejected from the test strip holder 200, with reference to FIGS. 11 to 13. FIGS. 11(a) and 11(b) are perspective views illustrating the test strip holding state (11(a)) and the test strip holding dissolving state (11(b)) of the test strip holder 200 of the second embodiment. FIGS. 12(a) and (b) are cross-sectional views of the respective states shown in FIGS. 11(a) and 11(b), respectively. Further, FIG. 13 is a diagram illustrating the state where the test strip 101 is discarded.

Initially, the user inserts the test strip 101 between the base 202 and the pivotable moving part 203 along the guides 212 of the moving part 203 to set the test strip 101 into the test strip holder 200. At this time, the user presses the test strip 101 until the notch 101a of the test strip 101 is fitted to the third elastic member 211. Thereby, the test strip 101 is pressed against the reference plane 206 by the third elastic member 211 to an extent that does not deform the test strip 101, whereby the test strip 101 is reliably held on the base 202. The state of the test strip holder 200 in which the test strip 101 is held is shown in FIGS. 11(a) and 12(a).

After the test strip 101 is set between the base 202 and the pivotable moving part 203 as described above, an analyte such as blood is applied to the set test strip 101. In this second embodiment, since the dent 205 is provided on the base 202 as in the first embodiment, the dent 205 prevents the analyte from adhering to the test strip holder 200 when it is applied. As a result, the base 202 is easily kept clean and the trouble of washing or decontamination can be saved, resulting in improved usability of the test strip holder 200.

Thereafter, the test strip holder 200 in its test strip holding state is inserted into the measurement apparatus 400 as shown in FIG. 3 to obtain measurement result. When the test strip holder 200 is inserted, the measurement apparatus 400 applies a light beam onto the upper surface of the test strip 101 to measure the result of reaction on the color region of the test strip 101, or to take an image of the color region, or to bring an instrument into contact with the test strip 101, thereby obtaining measurement result. After the measurement by the measurement apparatus 400 is ended, the test strip holder 200 is ejected from the measurement apparatus 400 while maintaining the test strip holding state as shown in FIGS. 11(a) and 12(a).

Thereafter, the used test strip 101 is ejected from the test strip holder 200. Initially, the user presses the eject button 204 of the pivotable moving part 203 downward to make the pivotable moving part 203 pivot upward with respect to the base 202. In accordance with this operation, as shown in FIGS. 11(b) and 12(b), the arm 210 provided on the pivotable moving part 203 holds up the test strip 101 to separate the test strip 101 from the base 202, and ejects the test strip 101 from the test strip holder 200. After the ejection, the user releases his/her hand from the eject button 204, whereby the pivotable moving part 203 and the eject button 204 are returned to the normal states by the fourth elastic member 215 provided beneath the eject button 204.

Accordingly, when the above-mentioned test strip ejecting operation of the test strip holder 200 after measurement is carried out above the waste box 500 while holding the handle part 208 of the test strip holder 200 to keep the test strip holder 200 in a downward direction from a horizontal position with respect to the ground as shown in FIG. 13, the test strip 101 can be ejected semiautomatically from the test strip holder 200 and discarded, without touching the test strip 101.

As described above, the test strip holder 200 according to the second embodiment is provided with the base 202, the pivotable moving part 203 provided on the base 202, and the third elastic member 211 for holding the test strip 101 at a predetermined position on the base 202, and the test strip 101 which is held by the third elastic member 211 between the pivotable moving part 203 and the base 202 is pivoted upward with respect to the base 202 to dissolve the test strip holding state, thereby ejecting the test strip 101. Therefore, the user can eject the test strip 101 easily and safely from the test strip holder 200 to discard the same, without touching the test strip 101.

Furthermore, according to the second embodiment, since the fourth elastic member 215 for restricting upward pivoting of the pivotable moving part 203 with respect to the base 202 is provided beneath the eject button 204, the pivotable moving part 203 does not pivot unless the user applies a force, thereby preventing the test strip 101 from being ejected by mistake.

Moreover, in this second embodiment, since the third elastic member 211 for pressing the test strip 101 against the reference plane 206 provided on the base 202 to hold the test strip 101 is provided on the base 202, the test strip 101 can be reliably held in the test strip holder 200.

While in this second embodiment the base 202 is rectangular in shape, the shape of the base 202 is not restricted thereto. The base 202 may have any shape, such as trapezoid, a shape including a curve in a portion thereof, ellipse, triangle, and the like.

### Embodiment 3

In the above-mentioned first and second embodiments, the test strip held in the test strip holder is ejected from the test strip holder by sliding the slidable moving part or pivoting the pivotable moving part, which are provided on the base 202. In this third embodiment, however, the eject button is slidable on the base, and the test strip is ejected from the test strip holder by sliding the eject button with respect to the base.

Hereinafter, a test strip holder according to the third embodiment of the invention will be described.

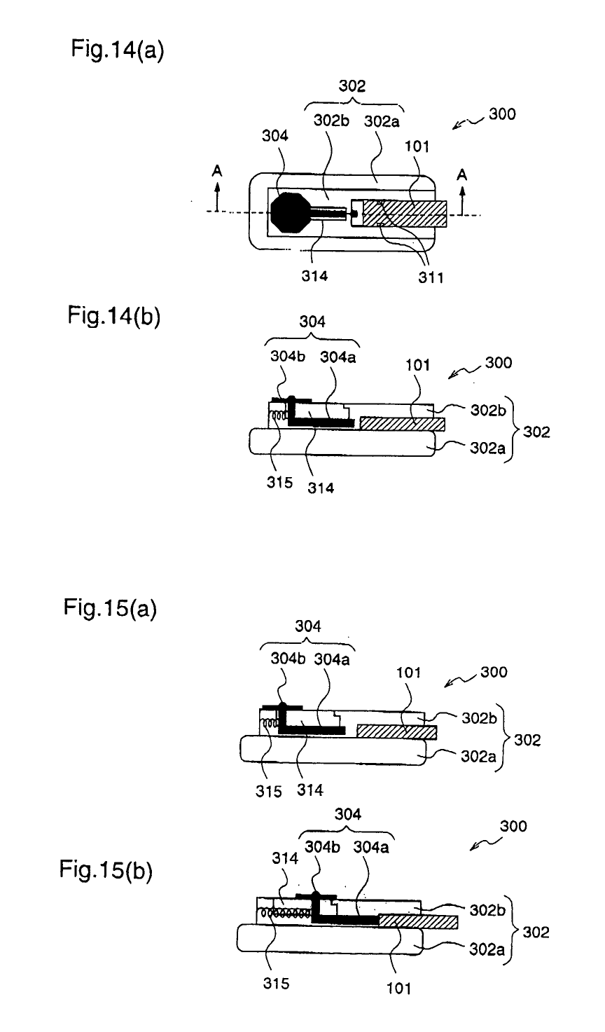

FIGS. 14(a) and 14(b) are diagrams illustrating the construction of the test strip holder according to the third embodiment. FIG. 14(a) is a plan view, and FIG. 14(b) is a cross-sectional view taken along a line A-A in FIG. 14(a).

With reference to the figures, the test strip holder 300 of the third embodiment is provided with a rectangle base 302 comprising a base lower part 302a and a base upper part 302b, and an eject button 304 which is disposed on the base upper part 302b and is a moving part that is slidable in the longitudinal direction of the base 302. When measuring the test strip 101, the test strip 101 is fixedly held in the base 302. After the measurement, the test strip holding state is dissolved by sliding the eject button 304 with respect to the base 302, whereby the test strip 101 is ejected semiautomatically from the test strip holder 300. Since the constituent materials of the test strip holder 300 of this third embodiment are identical to those described for the first embodiment, repeated description is not necessary.

Hereinafter, the construction of the test strip holder 300 according to the third embodiment will be described. The test strip 101 to be held by the test strip holder 300 of the third embodiment is identical to that described for the first embodiment.

The base 302 is made of a rectangular rigid body, and the base upper part 302b is fixed on the base lower part 302a, and the eject button 304 provided in the base upper part 302b slides in the longitudinal direction along a eject button guide 314 provided on the upper surface of the base upper part 302b.

Further, the base upper part 302b is provided with fifth elastic members 311 such as plate springs, which are fitted to the notches 101a of the test strip 101 and fixedly hold the test strip 101 at a predetermined position in the base 302. The test strip 101 inserted between the base upper part 302b and the base lower part 302a is held so as to be sandwiched by the fifth elastic members 311 in the transverse direction. To be specific, a space for receiving and holding the test strip 101 is provided between the lower surface of the base upper part 302b and the upper surface of the base lower part 302a. The test strip 101 is inserted from an end of this space, and the inserted test strip 101 is held by the fifth elastic members 311 that are provided in a rear position of this space.

Further, a front end of the base upper part 302b in the longitudinal direction on the side where the test strip 101 is set is U-shaped as in the first embodiment. When the test strip 101 is held in the test strip holder 300, the color region of the test strip 101 is exposed at an opening of the U-shaped part. A light beam is applied from the measurement apparatus 400 through this opening to tale upper surface of the test strip 101 to measure the result of reaction on the color region, or to take an image of the color region, or to bring an instrument into contact with the test strip 101.

The eject button 304 comprises a plane part 304b and an L-shaped projection 304a connected to the plane part 304b, and it is disposed backward in the longitudinal direction of the base upper part 302b. When ejecting the test strip 101 from the test strip holder 300, the eject button 304 is slid forward in the longitudinal direction in the base 302 along the eject button guide 314 to dissolve the test strip holding state, whereby the test strip 101 is ejected from the test strip holder 300. To be specific, when ejecting the test strip 101 from the test strip holder 300, the eject button is slid forward in the longitudinal direction to bring an end of the projection 304a in contact with the test strip 101, and then the eject button 304 is further slid forward in the longitudinal direction with the projection 304a being in contact with the test strip 101, thereby ejecting the test strip 101.

The projection 304a of the eject button 304 is desired to be reciprocatable in the base 302 because the projection 304a should not be an obstacle when the test strip 101 is set in the test strip holder 300. Further, in order to prevent erroneous operation, the eject button 304 is desired to be connected to the base 302 with a sixth elastic member 315 such as a coil spring to restrict sliding of the eject button 304 so that the eject button 304 does not slide unless the user applies a force to the plane part 304b of the eject button 304.

In this third embodiment, the plane part 304b and the eject button guide 314 of the eject button 304 are disposed on the upper surface of the base upper part 302b. However, the plane part 304b and the eject button guide 314 may be disposed in any position so long as the projection 304a of the eject button 304 can be in contact with the test strip 101. For example, the plane part 304b and the eject button guide 314 may be disposed on the side surface of the base 302 or on the bottom surface of the base lower part 302a. when the plane part 304b of the eject button 304 is disposed in a position that is hard for the user to touch, erroneous operation of the eject button 304 by the user can be avoided, thereby avoiding the test strip 101 from being ejected by mistake.

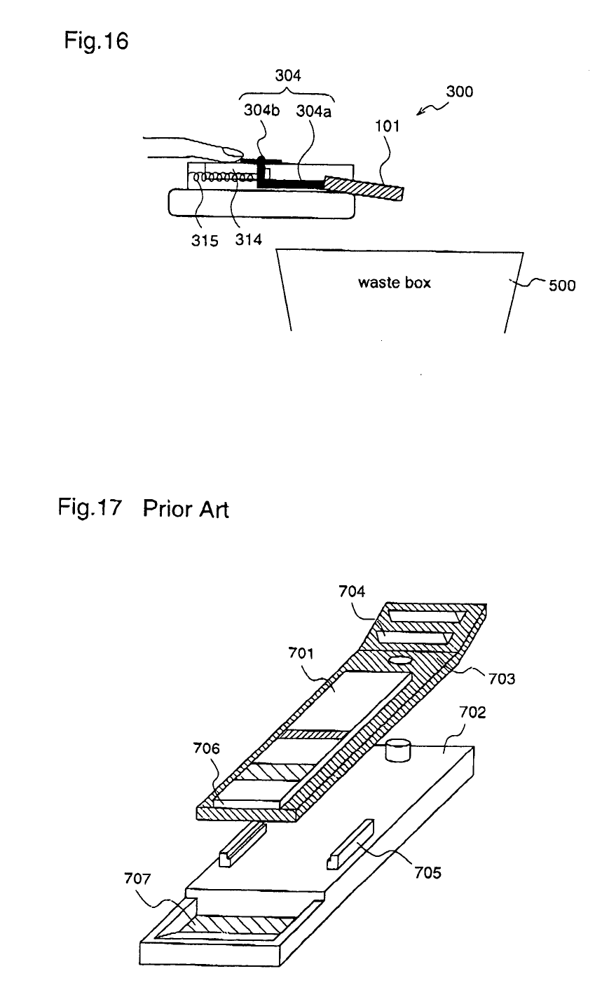

Next, a description will be given of the operation from when the test strip 101 is set in the test strip holder 300 of the third embodiment from the test strip 101 is ejected from the test strip holder 300. FIGS. 15(a) and 15(b) are cross-sectional views illustrating the test strip holding state (FIG. 15(a)) and the eject button sliding state (FIG. 15(b)) of the test strip holder of the third embodiment. FIG. 16 is a diagram illustrating the state where the test strip is discarded.

Initially, the user inserts the test strip 101 between the base lower part 302a and the base upper part 302b to set the test strip 101 in the test strip holder 300. At this time, the user presses the test strip 101 until the notches 101a of the test strip 101 are fitted to the fifth elastic members 311. Thereby, the test strip 101 is sandwiched by the fifth elastic members 311 in the transverse direction to be held in the base 302. The test strip holder 300 in its test strip holding state is shown in FIG. 15(a).

After the test strip 101 is held in the base 302 as described above, an analyte such as blood is applied onto the held test strip 101.

Thereafter, the test strip holder 300 in its test strip holding state is inserted into the measurement apparatus 400 as shown in FIG. 3, to obtain a measurement result. When the test strip holder 300 is inserted, the measurement apparatus 400 applies a light beam onto the upper surface of the test strip 101 to measure the result of reaction on the color region of the test strip 101, or to take an image of the color region, or to bring an instrument into contact with the test strip 101, thereby obtaining a measurement result. After the measurement by the measurement apparatus 400 is ended, the test strip holder 300 is ejected from the measurement apparatus 400 while maintaining the test strip holding state as shown in FIG. 15(a).

Thereafter, the used test strip 101 is ejected from the test strip holder 300. Initially, since the eject button 304 is usually held at a predetermined position by the sixth elastic member 315 so that the projection 304a of the eject button 304 does not contact the test strip 101, the user applies a force to the plane part 304b of the eject button 304 so as to slide the eject button 304 forward in the, longitudinal direction along the eject button guide 314. Thereby, the projection 304a of the eject button 304 is slid forward in the longitudinal direction in the base 302, and the tip of the projection 304a contacts an end of the test strip 101. Keeping this state, the plane part 304b of the eject button 304 is further slid forward in the longitudinal direction as shown in FIG. 15(b), whereby the projection 304a pushes the test strip 101 held in the base 302 backward. This operation dissolves the state where the test strip 101 is held by the fifth elastic members 311, and the test strip 101 can be ejected from the test strip holder 300. After the ejection, the user releases his/her hand from the plane part 304b of the eject button 304, whereby the eject button 304 moves to the original predetermined position along the eject button guide 314 by the elastic force of the sixth elastic member 315 connected to the eject button 304.

Accordingly, when the above-mentioned test strip ejecting operation of the test strip holder 300 after measurement is carried out above the waste box 500 while keeping the test strip holder 300 in a downward direction from a horizontal position with respect to the ground as shown in FIG. 16, the test strip 101 can be ejected semiautomatically from the test strip holder 300 and discarded, without touching the test strip 101.

As described above, the test strip holder 300 according to the third embodiment is provided with the base 302, the fifth elastic members 311 for fixedly holding the test strip 101 at a predetermined position in the base 302, and the eject button 304 which is slidable in the base 302 in the longitudinal direction, and the test strip 101 held in the base 302 by the fifth elastic members 311 is released by sliding the ejection button 304 forward in the longitudinal direction, whereby the test strip 101 is ejected from the test strip holder 300. Therefore, the user can easily and safely eject the test strip 101 from the test strip holder 300 to discard the same, without directly touching the test strip 101.

Further, in this third embodiment, the sixth elastic member 315 for pressing the eject button 304 backward in the longitudinal direction with respect to the base 302 to restrict forward sliding of the eject button 304 is located backward in the longitudinal direction in the base 302. Therefore, when the test strip 101 is held in the test strip holder 300, the test strip 101 is prevented from contacting the projection 304a of the ejection button 304, thereby preventing the test strip 101 from being ejected by mistake.

In this third embodiment, the eject button 304 is slid forward in the longitudinal direction to make it contact with the test strip 101, and the test strip 101 is pushed until the state where the test strip is held in the base 302 is dissolved, thereby discarding the test strip 101. However, the present invention is not restricted to this method. For example, the eject button 304 may be provided with a pivotable mechanism, and an arm engaged with the eject button 304 is brought in contact with the test strip 101 to push the test strip 101 until the state where the test strip 101 is held in the base 302 is dissolved. Also in this case, the same effects as mentioned above are achieved.

Furthermore, in this third embodiment, the fifth elastic members 311 are provided in the base upper part 302b, and the test strip 101 is held at a predetermined position in the base upper part 302b. However, the fifth elastic members 311 are not necessarily provided in the base upper part 302b. The fifth elastic members 311 may be provided in the base lower part 302a, and the test strip 101 may be held at a predetermined position in the base lower part 302a. Also in this case, the same effects as mentioned above are achieved.

Further, also in this third embodiment, a dent 205 may be provided on an end surface of the front part of the base 302 in the longitudinal direction on the side where the test strip 101 is set, and further, a handle part 208 may be provided at the other end of the base 302 in the longitudinal direction, with the same effects as mentioned for the first embodiment.

While in this third embodiment the base 302 is rectangular in shape, the shape of the base 202 is not restricted thereto. The base 202 may have any shape, such as trapezoid, shape including a curve in a portion thereof, ellipse, triangle, and the like.

### APPLICABILITY IN INDUSTRY

The test strip holder according to the present invention is useful as an apparatus for measuring an analyte with danger of infection, such as blood or blood plasma.

What is claimed is:

1. A test strip holder comprising:
a holding mechanism for holding a test strip which is inserted thereinto; and
an ejection mechanism for dissolving the state where the test strip is held by the holding mechanism to eject the test strip.

2. A test strip holder as defined in claim 1 wherein
said holding mechanism includes
a slidable moving part disposed on a base, which is slidable in a direction parallel to a direction along which the test strip is inserted, and
a first elastic member disposed in a predetermined position on the slidable moving part, which is engaged with the slidable moving part and presses the test strip against the base so that the slidable moving part holds the test strip between the slidable moving part and the base, and
said ejection mechanism dissolves the state where the test strip is held by the slidable moving part in the holding mechanism, and ejects the test strip, when the slidable moving part is slid with respect to the base from the test strip holding state.

3. A test strip holder as defined in claim 2 wherein
said ejection mechanism
includes an ejection button for changing the test strip holding state to a test strip holding dissolving state, said ejection button being disposed in a predetermined position on the base,
moves the test strip up to a predetermined position on the base while maintaining the position where the test strip is held by the slidable moving part, when the slidable moving part is slid in a direction opposite to the test strip insertion direction with respect to the base, from the test strip holding state,
stops the test strip at the predetermined position by the eject button, when the eject button is changed from the test strip holding state to the test strip holding dissolving state, and
dissolves the test strip holding state and discards the test strip, when the slidable moving part is slid by a predetermined distance or more in the test strip insertion direction with respect to the base.

4. A test strip holder as defined in claim 2 further including a second elastic member disposed at a rear position on the base, said second elastic member pressing the slidable moving part against the base in the test strip insertion direction to restrict sliding of the slidable moving part in a direction opposite to the test strip insertion direction.

5. A test strip holder as defined in claim 2 wherein
said ejection mechanism
includes an ejection elastic member for pressing the test strip against the slidable moving part so as to eject the test strip, and
presses the test strip by the ejection elastic member to eject the test strip after the test strip holding state is dissolved.

6. A test strip holder as defined in claim 1 wherein
said holding mechanism includes
a pivotable moving part disposed on a base, which is pivotable with respect to the base, and
a third elastic member disposed in a predetermined position on the base, which presses the test strip against the base so that the test strip is fixedly held at the position between the pivotable moving part and the base, and
said ejection mechanism dissolves the state where the test strip is held by the pivotable moving part, and ejects the test strip, when the pivotable moving part is pivoted upward with respect to the base from the test strip holding state.

7. A test strip holier as defined in claim 6 wherein
said ejection mechanism
includes an ejection button for changing the test strip holding state to a test strip holding dissolving state, said ejection button being disposed on the pivotable moving part,
pivots the pivotable moving part upward with respect to the base, from the state where the test strip is held by the pivotable moving part, when the eject button is changed from the test strip holding state to the test strip holding dissolving state, and
dissolves the test strip holding state and discards the test strip, when the pivot angle of the pivotable moving part becomes larger than a predetermined angle.

8. A test strip holder as defined in claim 7 further including a fourth elastic member disposed on the base, said fourth elastic member restricting upward pivoting of the pivotable moving part with respect to the base.

9. A test strip holder as defined in claim 1 wherein
said holding mechanism includes
a slidable moving part disposed in a base, which is slidable in a direction parallel to the test strip insertion direction, and
a fifth elastic member disposed in a predetermined position in the base, which fixedly holds the test strip at the position, and
said ejection mechanism dissolves the state where the test strip is held by the holding mechanism, and ejects the test strip, when the slidable moving part is slid with respect to the base from the test strip holding state.

10. A test strip holder as defined in claim 9 further including a sixth elastic member disposed at a rear position in the base, said sixth elastic member pressing the slidable moving part against the base in the test strip insertion direction to restrict sliding of the slidable moving part in a direction opposite to the test strip insertion direction.
